(19) United States
(12) Patent Application Publication
(10) Pub. No.: US 2012/0092219 A1
(43) Pub. Date: Apr. 19, 2012

(54) ANTENNA STRUCTURE USING MULTILAYERED SUBSTRATE

(75) Inventor: Dong-Young KIM, Daejeon (KR)

(73) Assignee: ELECTRONICS AND TELECOMMUNICATIONS RESEARCH INSTITUTE, Daejeon (KR)

(21) Appl. No.: 13/271,298

(22) Filed: Oct. 12, 2011

(30) Foreign Application Priority Data
Oct. 13, 2010 (KR) 10-2010-0099753
Apr. 12, 2011 (KR) 10-2011-0033745

(51) Int. Cl. H01Q 1/38

(52) U.S. Cl. 343/700 MS

(57) ABSTRACT

Disclosed is an antenna structure using a multilayered substrate, including: a multilayered substrate having a multilayered structure; a dielectric resonator formed in the multilayered substrate; a metal surface formed on the top surface of the multilayered substrate except for an upper area of the dielectric resonator; a ground surface formed on a layer border where the bottom surface of dielectric resonator is positioned in the multilayered substrate and including at least one aperture; and a feed line formed on the bottom surface of the multilayered substrate and transferring energy through the aperture.

### CROSS-REFERENCE TO RELATED APPLICATIONS

This application is based on and claims priority from Korean Patent Application No. 10-2010-0099753, filed on Oct. 13, 2010, and Korean Patent Application No. 10-2011-0033745, filed on Apr. 12, 2011, with the Korean Intellectual Property Office, the present disclosure of which is incorporated herein in its entirety by reference.

### TECHNICAL FIELD

The present disclosure relates to a high-gain antenna with a wideband characteristic in a millimeter wave band and high radiation efficiency. More particularly, the present disclosure relates to a new antenna structure with a high gain, high efficiency, and a wideband characteristic by using a dielectric resonator fabricated using a multilayered substrate.

### BACKGROUND

Frequencies of the millimeter wave band are more straightforward and have wideband characteristics as compared with those of micro wave band, thereby drawing attention in application to radars and communication services. Particularly, since wavelengths of the millimeter wave band are short, it is easy to manufacture small antennas and thus reduce system sizes largely. Among communication services in the millimeter wave band, 60-GHz broadband communication services and 77-GHz vehicle radar services have been fairly commercialized, and products thereof are now available on the market.

To provide small and inexpensive products by using the merits of millimeter wave band systems, much research is being conducted on system on package (SOP) systems, or system in package (SiP). Among methods of constructing such SiPs, a method of using a low temperature co-fired ceramic (LTCC) or liquid crystal polymer (LCP) technique is considered to be one of most suitable methods. According to an LTCC or LCP technique, basically, a multi-layer substrate is used, and passive devices such as a capacitor, an inductor, and a filter are built in the substrate, so that small and inexpensive modules can be provided. Another merit of using such a multi-layer substrate is that cavities can be freely formed, and thus the freedom of module configuration increases.

In the structure of an SiP system, an antenna patch is considered to a core element determining the system performance. In the case of a patch antenna operating in the millimeter wave band, particularly, ultrahigh frequency band of 60 GHz or higher, signal leakage occurs in the form of surface waves propagating along the surface of a dielectric substrate of the patch antenna. Such signal leakage increases as the thickness of the substrate increases and the dielectric constant of the substrate increases. Such signal leakage decreases the radiation efficiency and gain of the patch antenna. Although 60-GHz band communication systems require a wide bandwidth of 7 GHz or wider, it is difficult to satisfy such requirement by using a typical patch antenna structure.

Current commercial millimeter wave band modules have an SiP structure constructed by using an LTCC technique to reduce manufacturing costs. However, a ceramic substrate such as an LTCC substrate has higher dielectric constant than an organic substrate, and thus, if the ceramic substrate is used to form the patch antenna, since the radiation efficiency and gain of the patch antenna are low as described above, the number of antenna arrays should be much increased to obtain desired antenna gain, and it is difficult to obtain desired wideband characteristics. Therefore, commercial products are manufactured in a manner such that only antenna patches are formed of organic substrates having low dielectric constant. Thus, the size and manufacturing costs of modules are increased as compared with the case where the entire system including the antenna patch is mounted on an LTCC substrate in the form of an SiP.

### SUMMARY

The present disclosure has been made in an effort to provide a unique antenna structure with a dielectric resonator fed by aperture coupling, which has high efficiency, a high gain, and a wideband characteristic. These antennas can be easily fabricated using a multilayered substrate, in particular, a multilayered layer having a high dielectric constant such as LTCC.

The present disclosure has been made in an effort to fabricate an antenna operating in a millimeter wave frequency band, in particular, a ultrahigh frequency band of 60 GHz or more by using LTCC technology.

The present disclosure has been made in an effort to provide a high-efficiency, high gain antenna structure that prevents the surface wave excitation and has a wideband characteristic by implementing a unique-structure antenna on the ceramic substrate having the multilayered structure.

An exemplary embodiment of the present disclosure provides an antenna structure fabricated using a multilayered substrate, including: a multilayered substrate; a dielectric resonator formed in the multilayered substrate; a metal surface formed on the top surface of the multilayered substrate except for an upper area of the dielectric resonator; a ground surface formed on a layer border where the bottom surface of dielectric resonator is positioned in the multilayered substrate and including at least one aperture; and a feed line formed on the bottom surface of the multilayered substrate and feeding signal through the aperture.

The dielectric resonator may be surrounded by a via fence and the via fence may prevent a signal leakage through the multilayered substrate.

The via fence may be constituted by a plurality of via walls surrounding the dielectric resonator.

The size and thickness of the dielectric resonator may be determined to resonate at the desired frequency band.

A bandwidth of an antenna may be expanded by coupling the dielectric resonator and the feed line with each other through the aperture.

The dielectric resonator may have a circular or square cross section.

The metal surface may be constituted by a gold or silver electrode.

The ground surface may be constituted by the gold or silver electrode.

The size of the aperture may be determined to generate coupling with the dielectric resonator at desired frequencies.

The metal surface and the ground surface may be electrically connected to each other through a via.

The feed line may be a microstrip line.

The width of the aperture, the length of the aperture, and a feed length may be determined to couple the feed line and the dielectric resonator with each other at the desired frequency band.

The multilayered substrate may be low temperature cofired ceramics (LTCC).

According to the exemplary embodiments of the present disclosure, when an antenna is fabricated on a multilayered substrate such as LTCC having a relatively high dielectric constant, a surface wave is easily excited. The signal fed to the antenna leaked along the surface of the substrate by means of the surface wave, and thereby the radiation efficiency and the gain of the antenna is remarkably reduced. These surface wave excitation increases with increasing the thickness of the substrate, or increasing the dielectric constant of the substrate. A new-structure antenna is provided in order to prevent the propagation of the surface wave along the substrate surface. Another advantage of this new-antenna structure is wideband characteristics of the antenna.

In the exemplary embodiment of the present disclosure, the antenna is constituted by a dielectric resonator and a microstrip feed line in the multilayered substrate and a coupling aperture positioned on a ground surface in the multilayered substrate and the dielectric resonator is configured by using a via fence and at an outer part of the dielectric resonator, a metallic layer on the surface and an internal ground are connected through a via.

The dielectric resonator in the antenna is surrounded by plural metallic vias. These metallic vias prevents the signal leakage from dielectric resonator to the edge of the substrate. The signal fed to the dielectric resonator is radiated to the air. Accordingly, an antenna with high-efficiency and high-gain characteristics can be fabricated. Further, the signal is fed by a coupling through an aperture between a microstrip transmission line and the dielectric resonator, and as a result, a bandwidth of the antenna can be expanded by adjusting the size of the coupling.

Therefore, according to the exemplary embodiments of the present disclosure, a wideband antenna having a bandwidth of 10 GHz in an operating frequency of 60 GHz can be fabricated.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1A is a perspective view showing a structure of a microstrip patch antenna in the related art.

FIG. 1B is a cross-sectional view showing a structure of a microstrip patch antenna in the related art.

FIG. 2A is a graph showing a high frequency simulation software (HFSS) simulation result of a reflection characteristic (S11) of the patch antenna in the related art of FIG. 1.

FIG. 2B is a graph showing an HFSS simulation result of a radiation characteristic (antenna gain) of the patch antenna in the related art of FIG. 1.

FIG. 3A is a perspective view showing a structure of an antenna having a square dielectric resonator formed within a multilayered substrate according to an exemplary embodiment of the present disclosure.

FIG. 3B is a cross-sectional view showing a structure of an antenna having a square dielectric resonator formed within a multilayered substrate according to an exemplary embodiment of the present disclosure.

FIG. 4 is a diagram showing a feed line and a coupling aperture of the antenna structure according to an exemplary embodiment of the present disclosure.

FIG. 5A is a graph showing an HFSS simulation result of a reflection characteristic (S11) of the antenna with the square dielectric resonator of FIG. 3.

FIG. 5B is a graph showing an HFSS simulation result of a 60 GHz radiation characteristic (antenna gain) of the antenna with the square dielectric resonator of FIG. 3.

FIG. 5C is a graph showing an HFSS simulation result of variation of a gain depending on a frequency of the antenna with the square dielectric resonator of FIG. 3.

FIG. 6 is a conceptual diagram showing a structure of an antenna with a circular dielectric resonator formed in a multilayered substrate according to another exemplary embodiment of the present disclosure.

FIG. 7A is a graph showing an HFSS simulation result of a reflection characteristic (S11) of the antenna with the circular dielectric resonator of FIG. 6.

FIG. 7B is a graph showing an HFSS simulation result of a 60 GHz radiation characteristic (antenna gain) of the antenna with the circular dielectric resonator of FIG. 6.

FIG. 7C is a graph showing an HFSS simulation result of variation of a gain depending on a frequency of the antenna with the circular dielectric resonator of FIG. 6.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

Hereinafter, exemplary embodiments of the present disclosure will be described in detail with reference to the accompanying drawings.

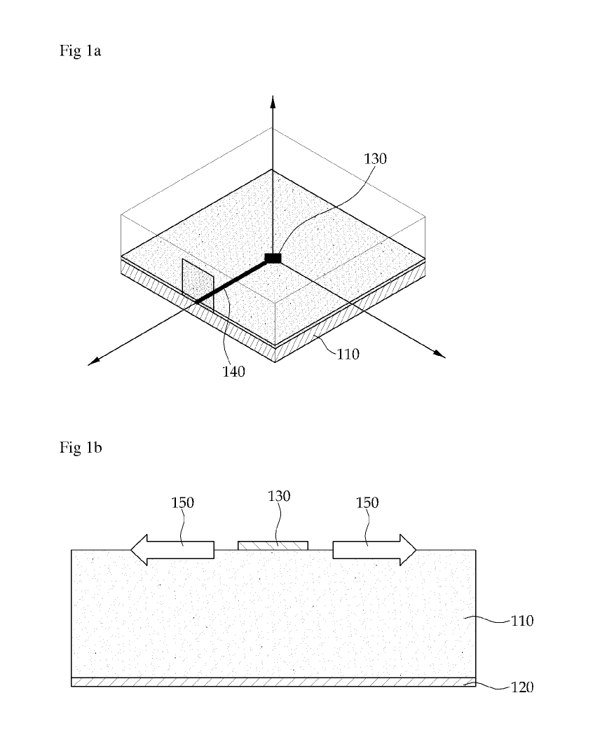

FIGS. 1A and 1B are a perspective view and a cross-sectional view showing a structure of a microstrip patch antenna in the related art, respectively.

Referring to FIG. 1A, a patch 130 and a feed line 140 are formed on a multilayered substrate 110. Multilayered substrate 110 may be configured by, for example, a 5-layer dielectric substrate and a dielectric constant of the substrate is approximately 7.2 and the thickness of one layer of the dielectric substrate may be approximately 0.1 mm.

Referring to FIG. 1B, a ground surface 120 is present in a lower part of multilayered substrate 110 and patch 130 is formed on the top surface of multilayered substrate 110. In the microstrip patch antenna in the related art, a signal is leaked in the form of a surface wave 150 along the surface of multilayered dielectric substrate 110.

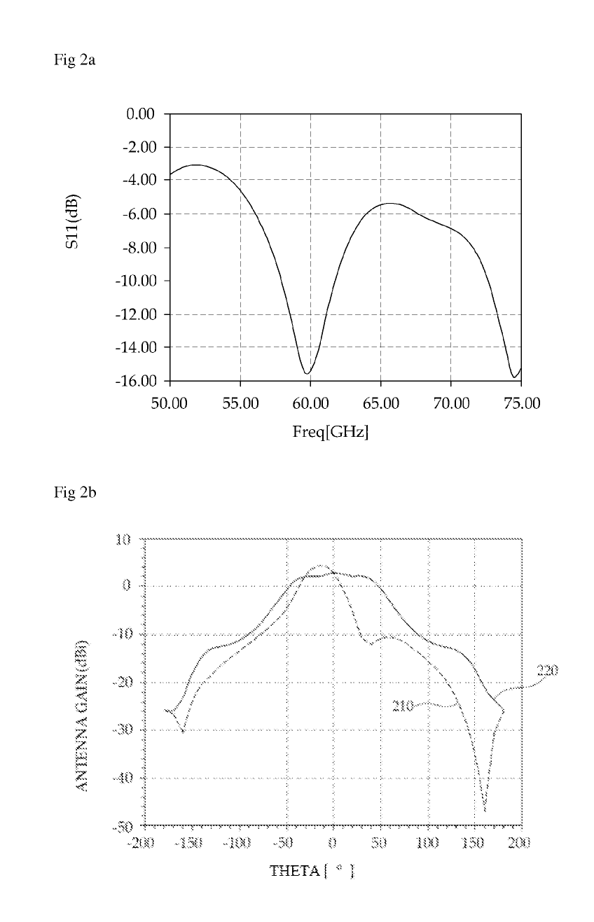

A result of an electromagnetic field simulation using high frequency simulation software (HFSS) of an antenna model shown in FIGS. 1A and 1B is shown in FIGS. 2A to 2C.

FIG. 2A is a graph showing a reflection characteristic of the antenna of FIG. 1. A horizontal axis represents a frequency (GHz) and a vertical axis represents a reflection loss (S11) parameter (dB). As shown in FIG. 2A, an antenna band having reflection loss S11 of 10 dB or more is in the range of approximately 58 to 61.8 GHz and the antenna of FIG. 1 has a bandwidth of approximately 3.8 GHz.

FIG. 2B is a graph showing a gain of the antenna and a horizontal axis represents a theta (°) and a vertical axis represents an antenna gain (dBi). FIG. 2B shows a graph 210 of a direction parallel to the feed line, that is, an E-plane and a graph 220 of a direction perpendicular to the feed line, that is, an H-plane.

As shown in FIG. 2B, the gain of the antenna of FIG. 1 has a maximum value of 4.2 dBi. In general, an ideal single patch antenna has the largest gain value perpendicular to the substrate. However, as shown in FIG. 2B, the antenna gain has the maximum value at a theta of −15°.

Further, since the patch has a rhombus shape, radiation characteristics in a parallel and perpendicular to the feed line are substantially similar to each other. However, as shown in FIG. 2B, the gain along the E-plane is symmetric across the theta, but the maximum point of the gain along the H-plane shifts by approximately 15° in the direction of the feed line. Due to the excitation of the surface wave, the signal is leaked along the top surface of the substrate to the substrate edge during the feeding. These leakage of signal due to surface wave excitation severely deteriorates the radiation characteristics of the antenna, and the maximum point of the gain shifts along the feeding direction. According to the simulation result, radiation efficiency of the antenna of FIG. 1 is 32.8%.

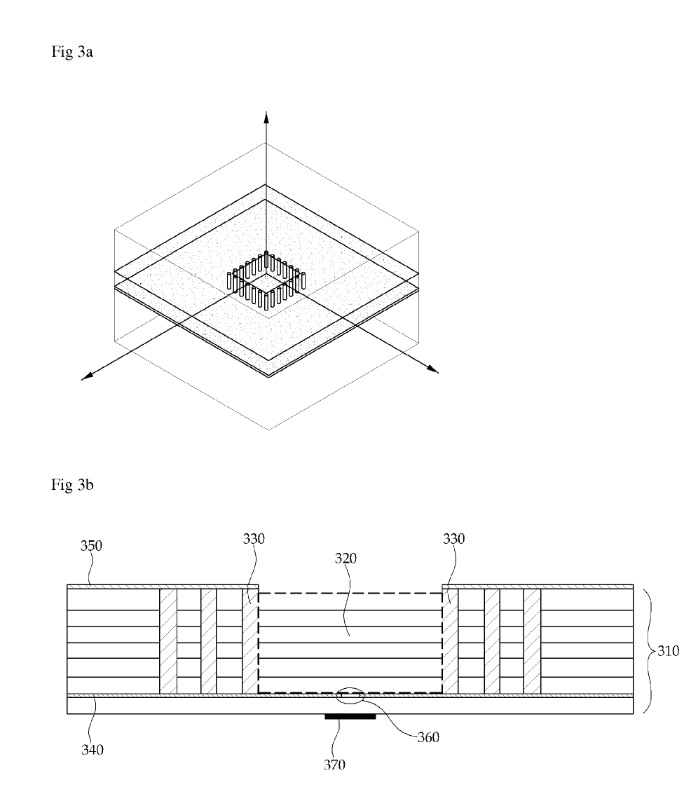

FIGS. 3A and 3B are a perspective view and a cross-sectional view showing a structure of an antenna with a square dielectric resonator formed within a multilayered substrate according to an exemplary embodiment of the present disclosure, respectively.

As shown in FIG. 3B, in the antenna structure of the exemplary embodiment of the present disclosure, a dielectric resonator 320 surrounded by a via fence 330 is positioned in a multilayered substrate 310. Via fence 330 may be constituted by a plurality of vias surrounding dielectric resonator 320. These vias act as a metal wall, and prevent the signal leakage through the substrate. The height and size of dielectric resonator 320 are designed to resonate in an operating frequency band.

The top surface of the antenna is covered with metal except for an upper area of dielectric resonator 320. Further, a ground surface 340 of the antenna is located on a layer border where the bottom surface of dielectric resonator 320 is positioned. The top metal surface 350 and the inner ground surface 340 are electrically connected using vias. The distance between vias are short enough to prevent signal leakage across these vias. Therefore, the signal fed to the antenna are accumulated in the dielectric resonator, and radiated only to the air through top surface of the dielectric resonator 320.

Referring to FIG. 3B, multilayered substrate 310 may be configured by a low temperature cofired ceramics (LTCC) multilayered substrate with a dielectric constant of 6.0 and tan δ of 0.0035. As shown in FIG. 3B, the antenna designed for 60 GHz application has total seven layers. Metal surface 350 formed on the surface of multilayered substrate 310 may be configured by a gold or silver electrode except for the upper area of the dielectric resonator. Further, dielectric resonator 310 occupies six layers from the top and may have a total thickness of 0.6 mm.

Dielectric resonator 320 may be formed by using the array of vias. The dielectric resonator 320 is surrounded by plural vias 330 to prevent the leakage of the signal across the dielectric body. The size of the dielectric resonator may be determined to resonate in a resonance frequency of 60 GHz.

Ground surface 340 located at the sixth layer in multilayered substrate 310 may be formed by a metal layer by using the gold electrode or silver electrode. In this case, an aperture 360 for power feeding is positioned in ground surface 340. The top metal surface 350 and the inner ground surface 340 may be electrically connected to each other by a via. Further, a microstrip line 370 for feeding the signal may be formed on the bottom layer of multilayered substrate 310.

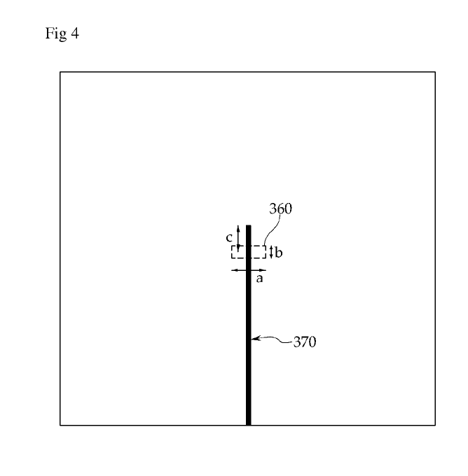

FIG. 4 is a diagram showing a feed line and a coupling aperture of the antenna structure according to an exemplary embodiment of the present disclosure.

As shown in FIG. 4, a microstrip line 370 for feeding the signal is positioned on the bottom surface of the multilayered substrate and a coupling aperture 360 for inputting the signal into the antenna is present on the inner ground surface. In this case, the length a of the aperture and the width b of the aperture, and a feed length c can be appropriately determined for smooth coupling between microstrip line 370 and dielectric resonator 320 in the operating frequency band of the antenna.

In such a structure, since the surface of the antenna is covered with metal, the excitation of the surface wave is impossible and the signal applied from the feed line is radiated outside only toward the top through dielectric resonator 320 without signal loss. Therefore, the antenna gain is not reduced. Further, due to a structure with aperture coupling between the dielectric resonator and microstrip line, an antenna with wideband characteristic can be easily implemented by simply adjusting the amount of coupling.

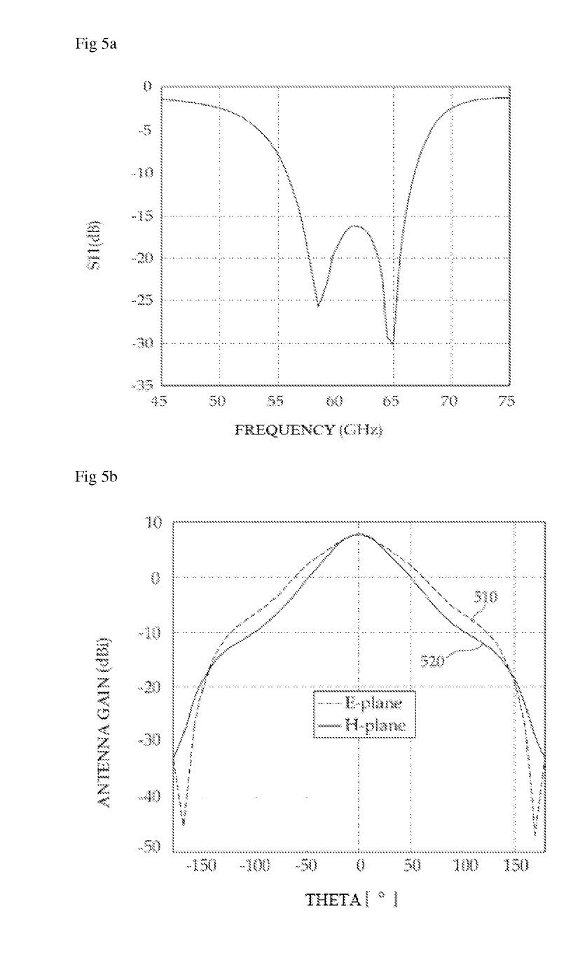

FIG. 5A is a graph showing an HFSS simulation result of a reflection characteristic (S11) of the antenna with the square dielectric resonator of FIG. 3.

As shown in FIG. 5A, the bandwidth of the antenna with reflection loss S11 of 10 dB or more is approximately 10.5 GHz (between 56 and 66.5 GHz). As compared with 3.8 GHz (see FIG. 2A) which is the bandwidth of the patch antenna structure in the related art shown in FIG. 1, a significant wideband characteristic can be acquired.

FIG. 5B is a graph showing an HFSS simulation result of a 60 GHz radiation characteristic (antenna gain) of the antenna with the square dielectric resonator of FIG. 3.

As shown in FIG. 5B, the gain of the antenna at 60 GHz is 7.8 dBi and the radiation efficiency of the antenna is 69.3% and the higher gain and higher efficiency characteristics are acquired as compared with 32.8% which is the radiation efficiency in the patch antenna structure in the related art shown in FIG. 1.

FIG. 5C is a graph showing an HFSS simulation result of the frequency dependency of a gain of the antenna with the square dielectric resonator of FIG. 3.

As shown in FIG. 5C, the antenna gain is 7.2 dBi or more and nearly flat within the antenna band of between 56 and 66.5 GHz.

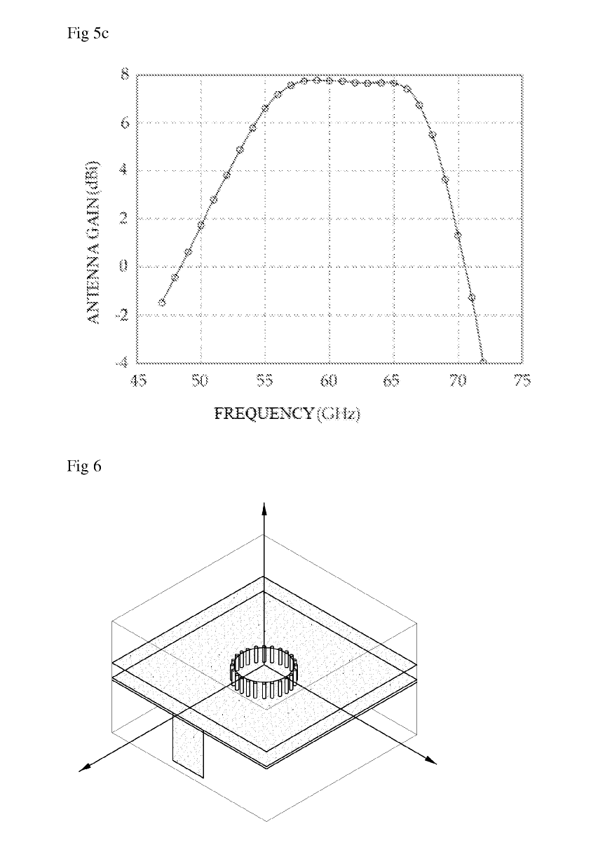

FIG. 6 shows a structure of an antenna with a circular dielectric resonator according to another exemplary embodiment of the present disclosure. Like the antenna with a square dielectric resonator shown in FIG. 3, the antenna is constituted by total seven layers on the LTCC multilayered substrate with the dielectric constant of 6.0 and tan δ of 0.0035. Further, the size of the dielectric resonator is designed to resonate at 60 GHz.

The feed length of the microstrip transmission line which is the feed line and the size of the aperture positioned on the ground surface may be designed to generate coupling with the circular dielectric resonator at 60 GHz.

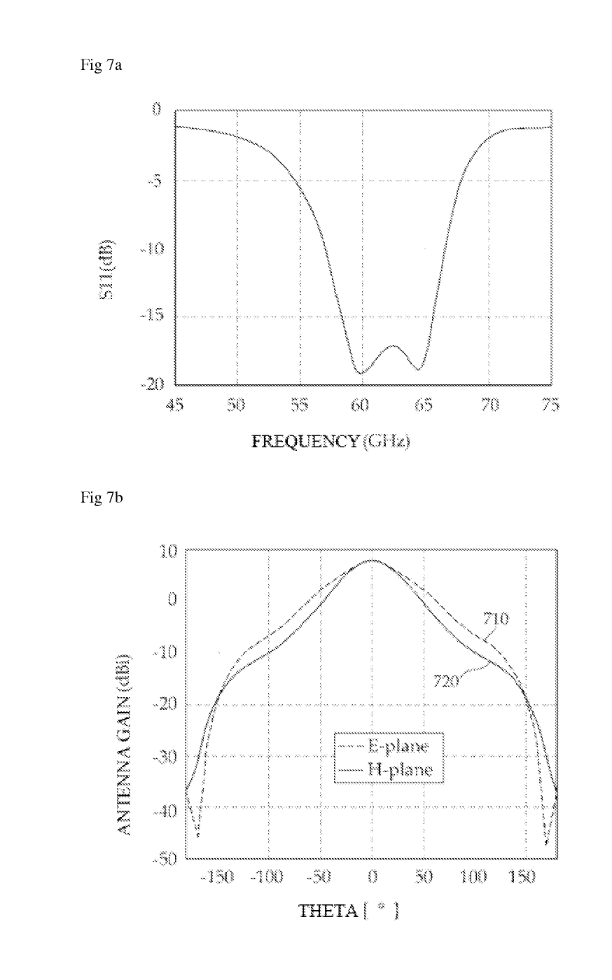

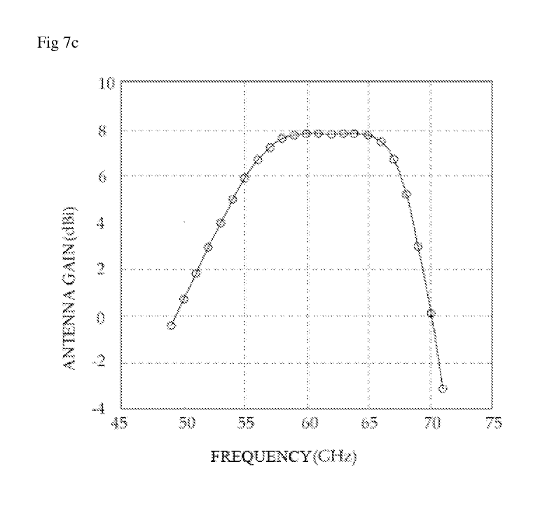

FIG. 7A is a graph showing an HFSS simulation result of a reflection loss (S11) of the antenna of FIG. 6.

As shown in FIG. 7A, the bandwidth of the antenna with reflection loss S11 of 10 dB or more is approximately 9.5 GHz (between 57 and 66.5 GHz). The bandwidth is similar to the value of the antenna with a square dielectric resonator shown in FIG. 3.

FIG. 7B is a graph showing an HFSS simulation result of a radiation characteristic (antenna gain) of the antenna of FIG. 6 at 60 GHz.

As shown in FIG. 7B, the antenna gain at 60 GHz is 7.9 dBi and the radiation efficiency of the antenna is 68.9%.

FIG. 7C is a graph showing an HFSS simulation result of the frequency dependency of a gain of the antenna of FIG. 6.

As shown in FIG. 7C, the antenna gain is 7.2 dBi or more and nearly flat within the antenna band between 57 and 66.5 GHz.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. An antenna structure using a multilayered substrate, comprising:
a multilayered substrate having a multilayered structure;
a dielectric resonator formed in the multilayered substrate;
a metal surface formed on a top surface of the multilayered substrate except for an upper area of the dielectric resonator;
a ground surface formed on a layer border where a bottom surface of the dielectric resonator is positioned in the multilayered substrate and including at least one aperture; and
a feed line formed on a bottom surface of the multilayered substrate and transferring energy through the aperture.

2. The antenna structure using a multilayered substrate of claim 1, wherein the dielectric resonator is formed in the multilayered substrate by using a via fence, and the via fence prevents a signal leakage through the multilayered substrate.

3. The antenna structure using a multilayered substrate of claim 2, wherein the via fence is constituted by a plurality of via walls surrounding the dielectric resonator.

4. The antenna structure using a multilayered substrate of claim 1, wherein the size and thickness of the dielectric resonator are determined to resonate in a used frequency band.

5. The antenna structure using a multilayered substrate of claim 1, wherein a bandwidth of an antenna is expanded by coupling the dielectric resonator and the feed line with each other through the aperture.

6. The antenna structure using a multilayered substrate of claim 1, wherein the dielectric resonator has a circular or square cross section.

7. The antenna structure using a multilayered substrate of claim 1, wherein the metal surface is constituted by a gold or silver electrode.

8. The antenna structure using a multilayered substrate of claim 1, wherein the ground surface is constituted by a gold or silver electrode.

9. The antenna structure using a multilayered substrate of claim 1, wherein the size of the aperture is determined to generate coupling with the dielectric resonator at a desired frequency.

10. The antenna structure using a multilayered substrate of claim 1, wherein the metal surface and the ground surface are electrically connected to each other through a via.

11. The antenna structure using a multilayered substrate of claim 1, wherein the feed line is a microstrip feed line.

12. The antenna structure using a multilayered substrate of claim 1, wherein the width of the aperture, the length of the aperture, and a feed length are determined to couple the feed line and the dielectric resonator with each other in an operating frequency band of the antenna.

13. The antenna structure using a multilayered substrate of claim 1, wherein the multilayered substrate is low temperature cofired ceramics.
